(19) United States
(12) Patent Application Publication
(10) Pub. No.: US 2010/0250061 A1
(43) Pub. Date: Sep. 30, 2010

(54) VEHICLE CONTROL DEVICE

(75) Inventors: Naoki Toyofuku, Toyota-shi (JP); Tomoyasu Ishikawa, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi (JP)

(21) Appl. No.: 12/741,999

(22) PCT Filed: Jan. 15, 2009
(86) PCT No.: PCT/JP2009/050424

§ 371 Date: May 7, 2010

(30) Foreign Application Priority Data
Jan. 15, 2008 (JP) 2008-005949

(51) Int. Cl. G06F 7/00

(52) U.S. Cl. 701/35

(57) ABSTRACT

A vehicle control device includes a control unit controlling an in-vehicle device and a status information acquisition unit acquiring status information of a vehicle and output the acquired status information to the control unit. In the vehicle control device, the control unit specifies a failure-cause-verification information to be used for verifying a cause of a failure from among the status information acquired by the status information acquisition unit, the failure-cause-verification information being specified by using a timing when a predetermined fail-safe control is started as a reference, the timing being determined based on the status information acquired by the status information acquisition unit, and the control unit stores the specified failure-cause-verification information in a predetermined storage medium.

### TECHNICAL FIELD

The present invention relates to a vehicle control device capable of storing status information when a failure occurs in a vehicle (including in-vehicle devices) so that the stored status information may be used to verify the cause of the failure afterwards.

### BACKGROUND ART

Conventionally, in a vehicle, information items such as a sensor output value, a control operation value, a status of the vehicle (including the in-vehicle devices) have been monitored and stored in a storage medium or the like when a failure of the vehicle is detected based on the monitored information. The stored monitored information may also be used afterwards in, for example, a service facility to verify (specify) the cause of the failure. Such verification of the cause of the failure may be called self-diagnosis (diagnosis). In a vehicle, a control device such as the ECU (Electronic Control Unit) generally performs the self-diagnosis while performing the vehicle control, the ECU being provided for controlling the vehicle.

There has been disclosed an invention of a vehicle information terminal device capable of storing information to be used for the self-diagnosis (see for example Patent Document 1). This vehicle information terminal device includes one or more vehicle electronic control devices, sensors, and an internal memory. The vehicle electronic control device includes both a vehicle control program and a diagnosis program for diagnosing each part of the vehicle. The sensor acquires status information of the vehicle. The internal memory sequentially stores vehicle information transmitted from the vehicle electronic control devices and the sensors. The vehicle information terminal device accumulates (stores) the vehicle information including a result of self-diagnosis into a recording device, the vehicle information being obtained from the electronic control devices and the sensors, the result of the self-diagnosis being obtained by using the diagnosis program. By having this configuration, in a case where a failure of the vehicle is detected based on the self-diagnosis using the diagnosis program, the vehicle information in the internal memory in a time period from a first timing when the failure of the vehicle is detected to a second timing when a predetermined time period has passed since the first timing is duplicated in the recording device to be accumulated in the recording device.

[Patent Document 1]: Japanese Patent Application Publication No.: 2005-43138

### DISCLOSURE OF THE INVENTION

### Problem to be Solved by the Invention

However, generally, such a vehicle electronic control device has a function to control to prevent the vehicle from falling into a dangerous driving condition by controlling the output of the in-vehicle devices after a possibility of occurrence of failure is detected (hereinafter, the control is referred to as “fail-safe control”). Further, from the viewpoints of security, it is general that the fail-safe control is designed to be started before it is determined that a failure occurs (i.e., the occurrence of the failure is confirmed or detected).

In such a conventional vehicle electronic control device, the vehicle information in the internal memory in a time period from a timing a predetermined period before the timing when the failure is detected may be duplicated in the recording device to be accumulated in the recording device. However, as described above, when the fail-safe control is once started, the output of the in-vehicle devices may be controlled (reduced). As a result, when the output of the in-vehicle devices may be controlled (reduced), the vehicle information of the sensor output value and the control operation value after the fail-safe control is once started may not be adequate to be used for verifying (specifying) the cause of the failure. Therefore, in a conventional vehicle electronic control device, there may arise a case where vehicle information adapted to be used for the verification of the cause of a failure cannot be successfully stored in the recording device.

The present invention is made in light of the above circumstance, and may provide a vehicle control device capable of storing vehicle information necessary for the self-diagnosis.

### Means for Solving Problem

According to a first aspect of the present invention, there is provided a vehicle control device including a control unit controlling an in-vehicle device, and a status information acquisition unit acquiring status information of a vehicle and output the acquired status information to the control unit. In the vehicle control device, the control unit specifies a failure-cause-verification information to be used for verifying a cause of a failure from among the status information acquired by the status information acquisition unit, the failure-cause-verification information being specified by using a timing when a predetermined fail-safe control is started as a reference, the timing being determined based on the status information acquired by the status information acquisition unit, and the control unit stores the specified failure-cause-verification information in a predetermined storage medium.

According to the first aspect of the present invention, the failure-cause-verification information specified by using the timing when the predetermined fail-safe control is started as the reference is stored in the predetermined recording medium. Because of this feature, it may become possible to store the information before and after the fail-safe control is started, the information being adapted to be used for verifying the cause of the failure.

Further, in this first aspect of the present invention, it may be preferable that the control unit specifies the failure-cause-verification information in a manner such that the failure-cause-verification information includes the status information acquired by the status information acquisition unit and before the timing when a predetermined fail-safe control is started, and stores the specified failure-cause-verification information in the predetermined storage medium.

According to a second aspect of the present invention, there is provided a vehicle control device including plural control units configured to control an in-vehicle device, and a status information acquisition unit configured to acquire status information of a vehicle and output the acquired status information to the control units. In the vehicle control device, the plural control units specify a failure-cause-verification information to be used for verifying a cause of a failure from among the status information acquired by the status information acquisition unit, the failure-cause-verification information being specified by using a timing when a predetermined fail-safe control is started as a reference, the timing being determined based on the status information acquired by the status information acquisition unit, and the plural control units store the specified failure-cause-verification information in a predetermined storage medium.

According to the second aspect of the present invention, the failure-cause-verification information specified by using the timing when the predetermined fail-safe control is started as the reference is stored in the predetermined recording medium. Because of this feature, it may become possible to store the information before and after the fail-safe control is started, the information being adapted to be used for verifying the cause of the failure.

Further, in this second aspect of the present invention, it may be preferable that the plural control units specify the failure-cause-verification information in a manner such that the failure-cause-verification information includes the status information acquired by the status information acquisition unit and before the timing when a predetermined fail-safe control is started, and store the specified failure-cause-verification information in the predetermined storage medium.

### EFFECT OF THE INVENTION

According to an embodiment of the present invention, it may become possible to provide a vehicle control device capable of storing useful vehicle information necessary for the self-diagnosis.

### BRIEF DESCRIPTION OF THE DRAWINGS

FIG. 1 is a drawing showing an exemplary entire configuration of a vehicle control device 1;

FIG. 2 is a table showing status information stored as time series data in a RAM 26, an internal memory 28 and the like.

FIG. 3 is a drawing showing a comparison between the vehicle information stored as a result of the self-diagnosis in a conventional vehicle control device and that in a vehicle control device according to an embodiment of the present invention;

FIG. 4 is a drawing showing a comparison between an accumulated data stored as a result of the self-diagnosis in a vehicle control device according to the embodiment of the present invention a conventional vehicle control device and that in a conventional vehicle control device; and

FIG. 5 is a drawing showing an exemplary entire configuration of a vehicle control device 1; and

FIG. 6 is drawing showing changes over time of status information values A monitored by ECUs 120 and 122.

### EXPLANATION OF LETTERS AND NUMERALS

1,2: VEHICLE CONTROL DEVICE
10, 110: STATUS INFORMATION ACQUISITION SENSOR GROUP
20, 120, 122: ECU
22: CPU
24: ROM
24A, 24B: PROGRAM
26: RAM
28: INTERNAL MEMORY
30,130: RECORDING MEDIUM
40,140: MULTIPLEX COMMUNICATION LINE
50, 150: IN-VEHICLE DEVICE

### BEST MODE FOR CARRYING OUT THE INVENTION

In the following, preferred embodiments to carry out the present invention are described with reference to the accompanying drawings.

### Embodiments

### First Embodiment

In the following, a vehicle control device 1 according to a first embodiment of the present invention is described. The vehicle control device 1 includes a control device such as ECU (Electronic Control Unit) performing respective vehicle control (e.g., engine control, braking control, steering control, shift control or the like), so that the control device such the ECU performs self-diagnosis in addition to its primary process. However, the present invention is not limited to this configuration. For example, there may be additionally (externally) provided a dedicated device for performing the self-diagnosis in a manner such that a body of the dedicated device is different from that of the control device.

### Exemplary Configuration

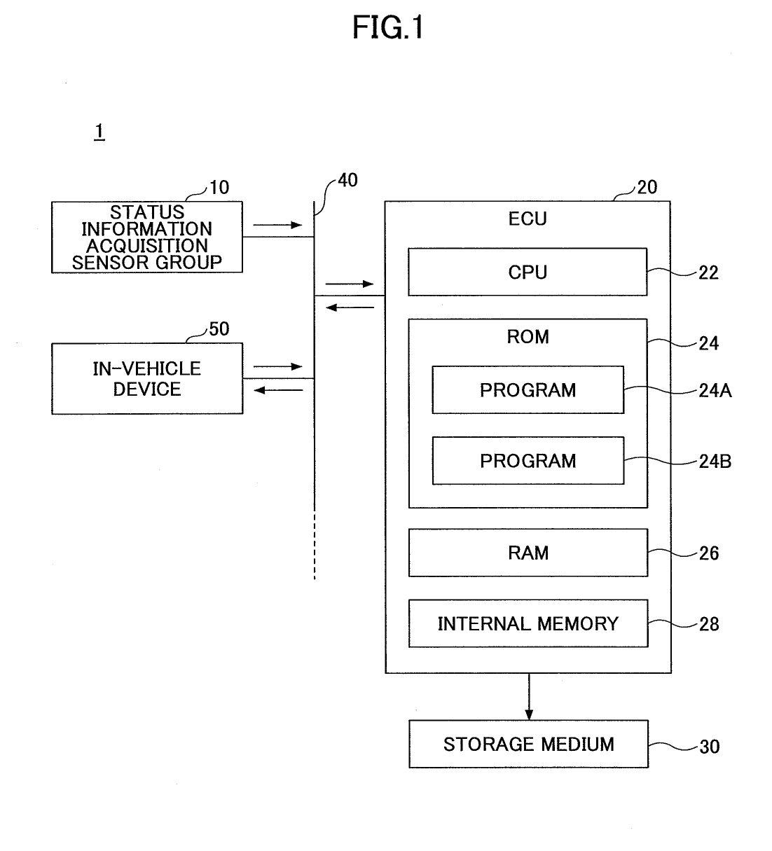

FIG. 1 shows an example of an entire configuration of the vehicle control device 1. As shown in FIG. 1, the vehicle control device 1 includes, as main components, a status information acquisition sensor group 10, an ECU (Electronic Control Unit) 20, and a storage medium 30 for storing information to be used for verification of cause of failure. Alternatively, the storage medium 30 may be included in the ECU 20. The status information acquisition sensor group 10 and the ECU 20 are electrically connected with each other via, for example, a multiplex communication line 40 so as to communicate with each other using an appropriate communication protocol such as CAN (Controller Area Network), BEAN, AVC-LAN, FlexRay and the like. However, the above configuration is described for simplification and illustrative purposes only. Therefore, for example, the sensor output value may be input to the ECU 20 via other ECU, a gateway computer or the like.

For example, the status information acquisition sensor group 10 may include a water temperature sensor, various types of pressure sensors, a vehicle speed sensor, a voltage sensor, a gravity sensor, a yaw rate sensor, an accelerator opening sensor, a throttle opening sensor, a brake depression amount sensor (a master pressure sensor), a shift position switch, and the like.

The ECU 20 includes a computer unit having, for example, a CPU (Central Processing Unit) 22 as its main component, a ROM (Read Only Memory) 24, and a RAM (Random Access Memory) 26. The ECU 20 further includes an internal memory 28 and other elements (not shown) such as an I/O port, a timer, a counter and the like. Those elements of the ECU 20 are electrically connected with each other via a bus. The ROM (Read Only Memory) 24 stores a program 24A causing the CPU 22 to perform vehicle control, a program 24B for monitoring a vehicle status and storing information, other programs, and other data.

Via the multiplex communication line 40, the ECU 20 is electrically connected with in-vehicle device 50 to be controlled (such as an actuator, an engine, a transmission, a braking device, a steering device and other devices). For example, when the ECU 20 is primarily for engine control, the in-vehicle device 50 may correspond to devices such as a throttle motor, an igniter, an injector and the like. Further, when the ECU 20 is primarily for braking control, the in-vehicle device 50 may be devices such as a braking actuator and the like.

The storage medium 30 ultimately stores the information for verification of cause of failure. As the storage medium 30, an NVRAM (Non-Volatile RAM) may be used in which an EEPROM (Electronically Erasable Programmable ROM) or an SRAM (Static RAM) having an internal or external small battery. Alternatively, as the storage medium 30, any other appropriate recording medium may be used such as a flash memory, a magnetic disk, a magnetic tape, a sheet (print sheet), or the like.

The ECU 20 controls the in-vehicle device 50 based on status information input (transmitted) from the status information acquisition sensor group 10. In the following, for explanatory purposes, a case is described where the ECU 20 is primarily for engine control. In this case, the ECU 20 drives a throttle motor to adjust throttle opening, controls ignition timing of the igniter and the like based on the information of the accelerator opening, the vehicle speed, the shift position and the like.

Further, the ECU 20 performs the fail-safe control based on the status information input (transmitted) from the status information acquisition sensor group 10. Herein, the fail-safe control refers to control to prevent the vehicle from falling into a dangerous driving condition by controlling the output of the in-vehicle devices after a possibility of occurrence of failure is detected. As a simple example of the engine control, when the output value of the accelerator opening sensor exceeds its upper limit value, it is determined that a failure occurs at least one of the accelerator opening sensor and its communication route. In this case, the ECU 20 performs such control as to keep the throttle opening at a low level regardless of the input (received) value of the accelerator opening so as to prevent the vehicle from falling into a dangerous driving condition due to unintended increase of the vehicle speed.

### Exemplary Process

In the following, an exemplary process according to the first embodiment of the present invention is described, the process being performed by executing the program 24B by the CPU 22 of the ECU 20, the program 24B being stored in the ROM 24.

The status information input (transmitted) from the status information acquisition sensor group 10 to the ECU 20 is stored in the RAM 26, the internal memory 28 and the like at a predetermined cycle (e.g., every several hundreds of milliseconds). In this case, the ECU 20 may extract (sample) the sensor output value at the predetermined cycle, or the sensors may output their output values at the predetermined cycle.

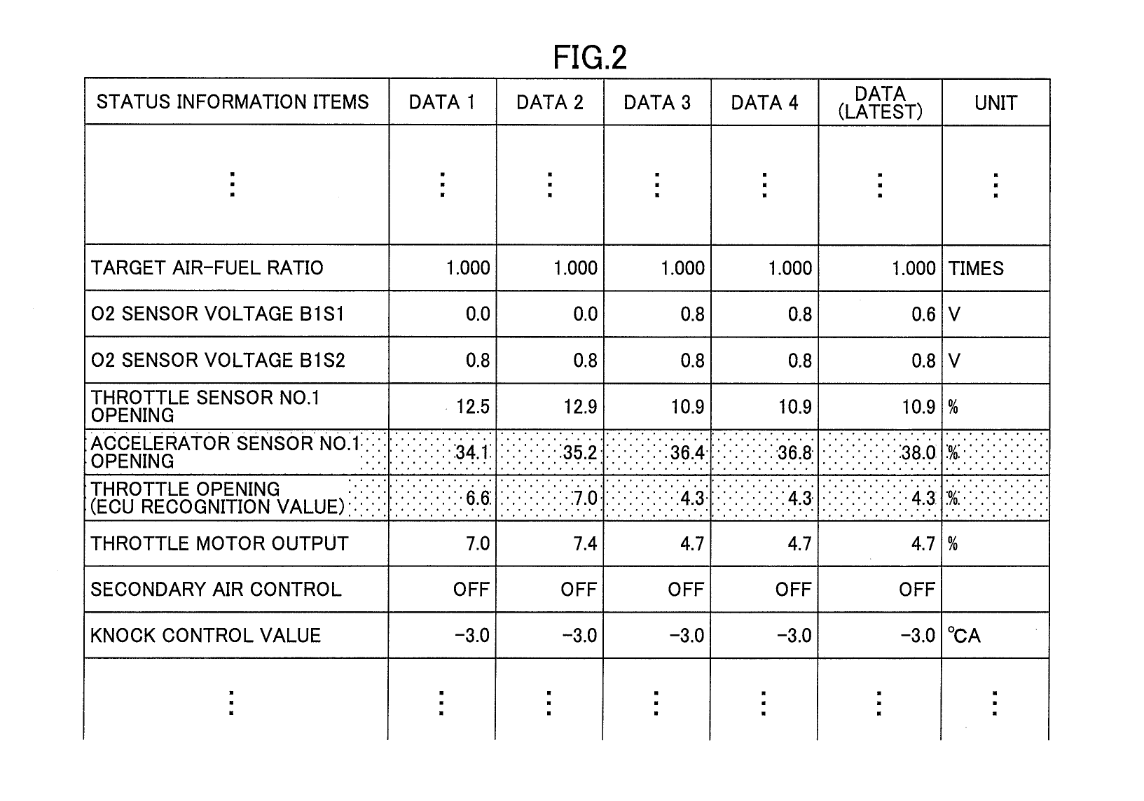

FIG. 2 illustrates a part of the status information input from the status information acquisition sensor group 10 and stored as time series data in the RAM 26, the internal memory 28 and the like. In FIG. 2, the accelerator opening is expressed as “ACCELERATOR SENSOR No. 1 OPENING”. Further, in FIG. 2, it is assumed that the fail-safe control to keep the throttle opening at a low level has already started when the status information expressed as “DATA 3” is input.

The ECU 20 controls the RAM 26, the internal memory 28 and the like so that the RAM 26, the internal memory 28 and the like store the status information within a time period from a timing a first predetermined timing period before the start timing of the fail-safe control to a timing a second predetermined timing period after the start timing of the fail-safe control (and no data are overwritten on the status information within the time period). In the table of FIG. 2, the status information (in this case, especially the accelerator opening and the throttle opening) in a range, for example, from data 1 though data 4 are stored. The stored status information is specified as the information for verification of cause of failure to be used for verifying (specifying) the cause of the failure. Further, it is preferable that the first predetermined timing period is equal to or longer than the second predetermined timing period. Further, it is preferable to vary those predetermined time periods depending on the type of the failures.

Further, the ECU 20 determines whether a failure occurs in the vehicle based on the status information input (transmitted) from the status information acquisition sensor group 10 after a predetermined period of monitoring. Then, at the timing when determining that the failure occurs in the vehicle, the ECU 20 stores the status information as time series freeze frame data (FFD data) into the storage medium 30, the status information having been input within the time period from the timing the first predetermined timing period before the start timing of the fail-safe control to the timing the second predetermined timing period after the start timing of the fail-safe control. Generally, the timing when determining that a failure occurs in the vehicle is after the timing when the fail-safe control starts. Further, it may be preferable to issue an alarm using a predetermined HMI (Human Machine Interface) when determining that the failure occurs in the vehicle. By alarming in this way, a customer (crew) of the vehicle may recognize the occurrence of the failure and determine to have the vehicle repaired in a service facility or the like. Then, in a repairing site, it may become possible to quickly verify (determine) the cause of the failure by referring to (reviewing) the information for verification of cause of failure stored in the storage medium 30 as described above.

Further, to prepare for legislative requirements, the status information before and after the timing when determining that the failure occurs in the vehicle may also be stored in the storage medium 30.

By storing the status information described in the above exemplary process, it may become possible to store the status information that is obtained before the fail-safe control starts and that is adequate to be used for verifying the cause of the failure in the storage medium 30. Because of this feature, it may become possible to provide a vehicle control device capable of storing necessary information adequate to be used for the self-diagnosis.

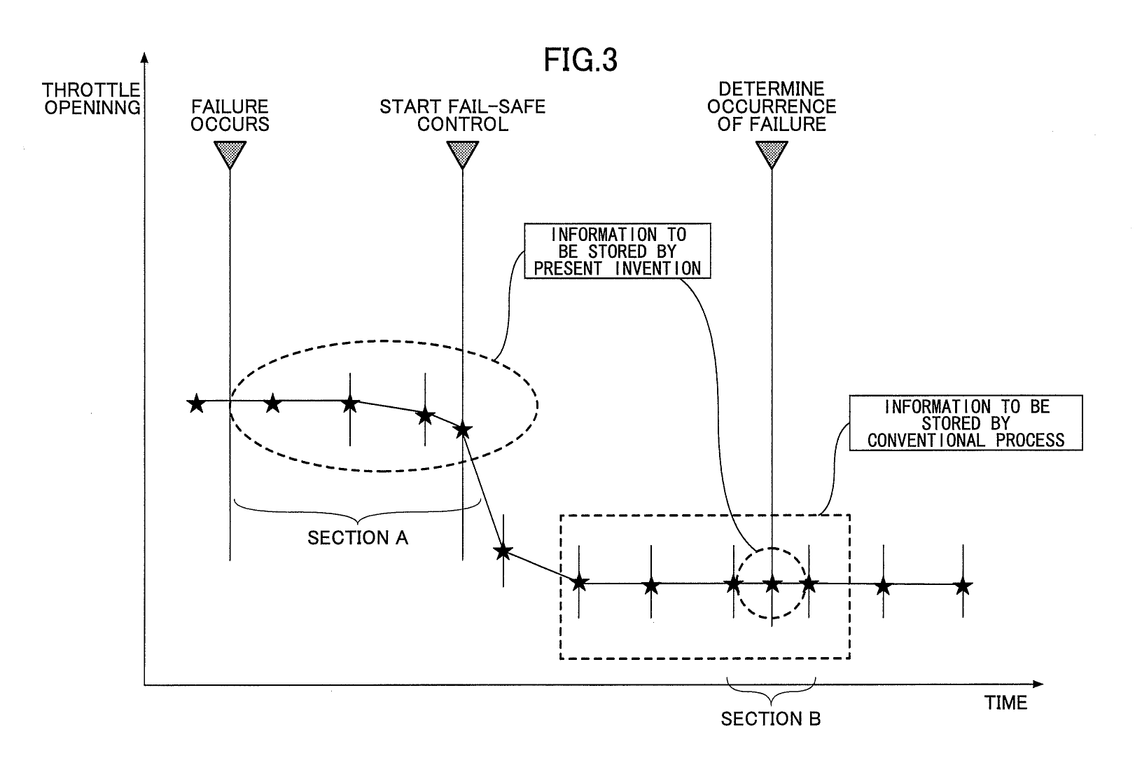

Next, a comparison is made between the above-described process of storing the information adequate to be used for the self-diagnosis according to this embodiment of the present invention and a conventional process. FIG. 3 shows a comparison between the information stored in the conventional process for the self-diagnosis and the information stored in the process according to this embodiment of the present invention for the self-diagnosis. As shown in FIG. 3, in the convention process, the information in a time period from a timing a predetermined time period before the timing when determining that the failure occurs in the vehicle to the timing when determining that the failure occurs in the vehicle has been generally stored. However, as described above, when the fail-safe control is once started, the outputs of the in-vehicle devices may be controlled (reduced). As a result, the sensor output value and the control operation value after the fail-safe control starts may no longer be adequate to be used for the verification of the cause of the failure. Because of this feature, in a conventional vehicle control device, the information adequate to be used for the verification of the cause of the failure may not be stored in the recording medium.

On the other hand, in a process performed in the vehicle control device according to this embodiment of the present invention, the information for verification of cause of failure is specified and stored in the storage medium 30 in a manner such that the information includes the information within the time period from the timing the first predetermined timing period before the start timing of the fail-safe control to the timing the second predetermined timing period after the start timing of the fail-safe control. By storing the information in this way, it may become possible to store both the information before the fail-safe control starts (i.e. the information in section A of FIG. 3), namely the information before it is determined that the failure occurs, and failure-confirmed-information (information after failure is confirmed) in which the data has been changed (i.e., the information in section B of FIG. 3). Because of this feature, it may become possible to secure the self-diagnosis accuracy. Therefore, it may become possible to store the information adequate to be used for verifying the cause of the failure in the storage medium 30.

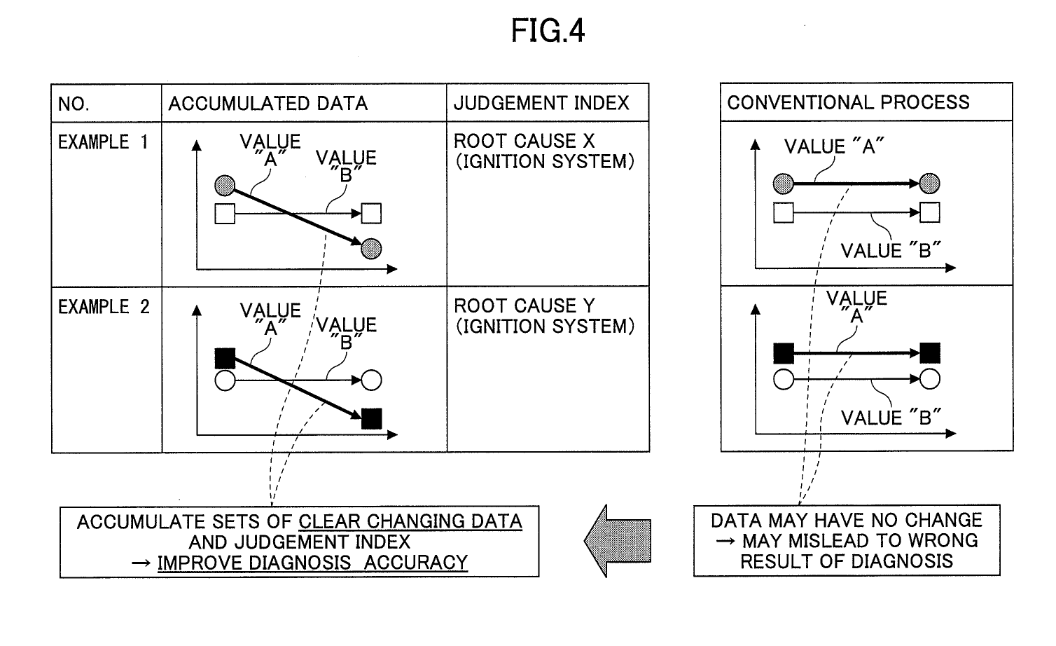

FIG. 4 shows another comparison between the stored (accumulated) data in the process according to this embodiment of the present invention for the self-diagnosis and the stored (accumulated) data in the process for the self-diagnosis in the conventional process. As shown in FIG. 4, in the conventional process, the accumulated data may be substantially unchanged over time. On the other hand, in the process according to this embodiment of the present invention, as shown in FIG. 4, it may become possible to store (accumulate) data that indicate the change of the data over time and that include the relevant judgement index as well. Because of this feature, when the process according to this embodiment of the present invention is used, it may become possible to improve the self-diagnosis accuracy.

As described above, the vehicle control device 1 according to this embodiment of the present invention may store necessary information more adequate to be used for the self-diagnosis.

### Second Embodiment

In the following, a vehicle control device 2 according to a second embodiment of the present invention is described. The vehicle control device 2 includes plural control device such as ECUs (Electronic Control Units) performing respective vehicle controls (e.g., engine control, braking control, steering control, shift control and the like), so that the control devices such the ECUs perform the respective self-diagnoses in addition to its primary processes. However, the present invention is not limited to this configuration. For example, there may be additionally (externally) provided dedicated devices for performing the self-diagnoses in a manner such that the bodies of the dedicated devices are different from those of the respective control devices.

### Exemplary Configuration

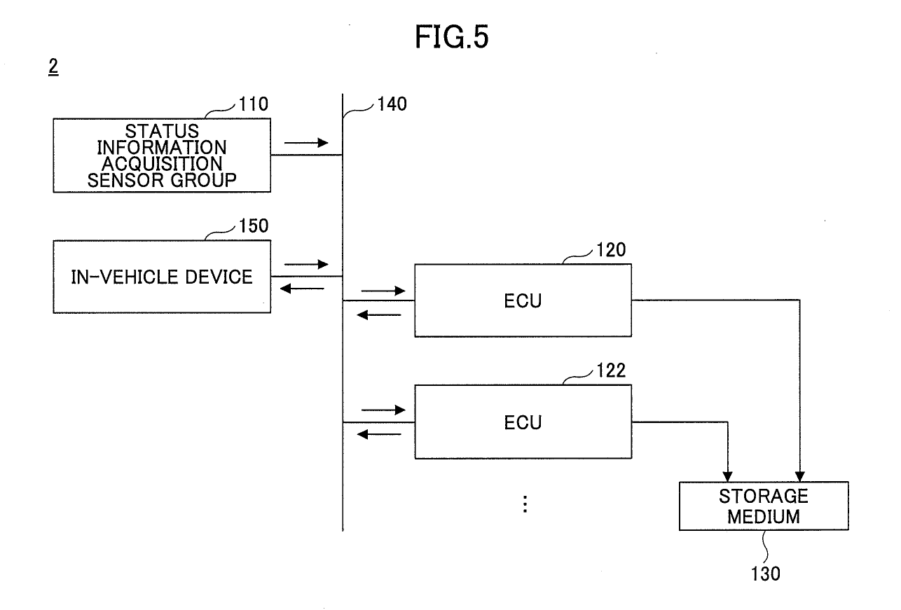

FIG. 5 shows an example of an entire configuration of the vehicle control device 2. As shown in FIG. 5, the vehicle control device 2 includes, as main components, a status information acquisition sensor group 110, plural ECUs (Electronic Control Units) 120 and 122 (there is no limitation in the number of the ECUs) (hereinafter may be collectively simplified as ECUs), and a storage medium 130 for storing information for verification of cause of failure. Alternatively, the storage medium 130 may be separately included in the ECUs 120 and 122. The status information acquisition sensor group 110 and the ECUs are electrically connected with each other via, for example, a multiplex communication line 40 so as to communicate with each other using an appropriate communication protocol such as CAN (Controller Area Network), BEAN, AVC-LAN, FlexRay and the like. However, the above configuration is described for simplification and illustrative purposes only. Therefore, for example, the sensor output value may be input to the ECU 20 via other ECU, a gateway computer or the like.

This status information acquisition sensor group 110 is similar to the status information acquisition sensor group 10 described in the first embodiment of the present invention; therefore, the repeated description thereof is herein omitted.

Each of the ECUs has the similar hardware configuration to that of the ECU 20 according to the first embodiment of the present invention; therefore, the repeated description thereof is herein omitted.

Via the multiplex communication line 40, each of the ECUs 20 is electrically connected with an in-vehicle device 150 to be controlled (such as an actuator, an engine, a transmission, a braking device, a steering device and other devices). For example, when one of the ECUs is primarily for engine control, the in-vehicle device 150 may correspond to the devices such as a throttle motor, an igniter, an injector and the like. Further, when the ECU 20 is primarily for braking control, the in-vehicle device 150 may correspond to devices such as a braking actuator and the like.

Similar to the storage medium 30 described in the first embodiment of the present invention, the storage medium 130 also ultimately stores the information for verification of cause of failure.

Each of the ECUs controls the in-vehicle device 150 based on status information input (transmitted) from the status information acquisition sensor group 110.

Further, each of the ECUs performs the fail-safe control based on the status information input (transmitted) from the status information acquisition sensor group 110 or based on control status information of other ECU input (transmitted) from the other ECU. The fail-safe control performed in this embodiment is similar to that described in the first embodiment of the present invention; therefore, the repeated description is herein omitted.

### Exemplary Process

In the following, an exemplary process executed by the ECUs according to the second embodiment of the present invention is described.

The status information input (transmitted) from the status information acquisition sensor group 10 to the ECUs is stored in the respective RAM 26, internal memory 28 and the like of at a predetermined cycle (e.g., every several hundreds of milliseconds). In this case, the ECUs may extract (sample) the sensor output value at the predetermined cycle, or the sensors may output their output values at the predetermined cycle.

As described above, each of the ECUs performs the fail-safe control based on the status information input (transmitted) from the status information acquisition sensor group 110 or based on the information of other ECU input (transmitted) from the other ECU. For explanatory purposes, herein, it is assumed that the ECU 120 is primarily for engine control and the ECU 122 is primarily for braking control. In this case, for example, when determining that a failure occurs in the engine due to a relationship between the throttle opening and the tube internal pressure, the ECU 120 performs the fail-safe control to control the engine output (there may be a case where the fail-safe control is not performed), and notifies other ECU(s) (e.g., ECU 122) of the fact that the failure is occurred, the status information used to determined the fact and the like. The other ECU(s) (e.g. ECU 122) starts the fail-safe control at the timing when the information is received from the ECU 120 even if all of the output values of the status information acquisition sensor group 110 monitored by the other ECU(s) (e.g. ECU 122) are normal.

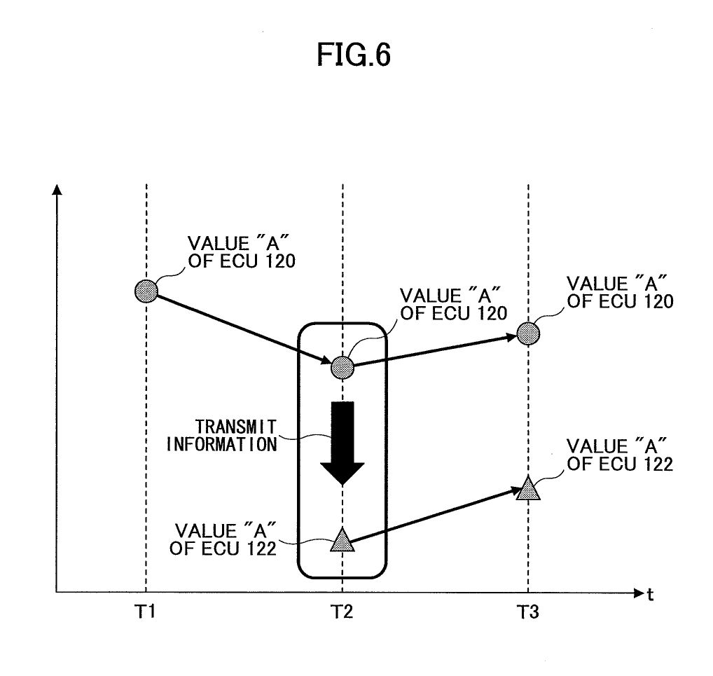

FIG. 6 shows an example of changes over time of status information values A monitored by ECUs 120 and 122. As shown in FIG. 6, the ECU 120 transmits the information of the status information value A monitored by the ECU 120 to the ECU 122 so as to share the status information among the ECU 120 and the ECU 122. By doing in this way, it may become possible (for the ECU 122 in this case) to start its fail-safe control at the timing of detecting the change of the status information monitored by the other ECU (ECU 120 in this case).

Further, similar to the first embodiment, each of the ECUs controls the RAM, the internal memory and the like so that the RAM, the internal memory and the like store the status information within the time period from the timing the first predetermined timing period before the start timing of the fail-safe control to the timing the second predetermined timing period after the start timing of the fail-safe control. Further, each of the ECUs determines whether a failure occurs in the vehicle based on the status information input (transmitted) from the status information acquisition sensor group 110 or the information input (transmitted) from the other control device after a predetermined period of monitoring. Then, at the timing when determining that the failure occurs in the vehicle, the ECU stores the information in the storage medium 130 as time series freeze frame data (FFD data), the information being the status information within the time period from the timing the first predetermined timing period before the start timing of the fail-safe control to the timing the second predetermined timing period after the start timing of the fail-safe control. Further, to prepare for legislative requirements, the status information before and after the timing when determining that the failure occurs in the vehicle may also be stored in the storage medium 130.

By storing the status information described in the above exemplary process, it may become possible to store the status information in the storage medium 130, the status information having been obtained before the fail-safe control starts and being adequate to be used for verifying the cause of the failure. Because of this feature, it may become possible to provide a vehicle control device capable of storing necessary information adaptive to be used for the self-diagnosis.

Further, in this embodiment of the present invention, as described above, each of the ECUs may start the fail-safe control at the timing of detecting the information that other ECU detects the failure of the in-vehicle device 150 (vehicle), and also starts storing the information as the FFD data. Because of this feature, it may become possible to collect more status information before and after the failure occurs in the in-vehicle device 150 (vehicle). Further, even in a case where a first ECU having detected the failure of the in-vehicle device 150 does not perform the fail-safe control but a second ECU having received the information that the first ECU have detected the failure performs the fail-safe control, the FDD data are stored in the storage medium 130. Because of this feature, it may become possible to collect more status information before and after the failure occurs in the in-vehicle device 150 (vehicle). As a result, it may become possible to improve the self-diagnosis accuracy.

As described above, the vehicle control device 2 according to the second embodiment of the present invention may store wider range of necessary information adaptive to be used for the self-diagnosis.

### Modifications

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

For example, in the above description, a case is described where the status information transmitted from the status information acquisition sensor group is temporarily stored in the RAM, the internal memory and the like, and then, the information for verification of cause of failure is specified from among the stored status information and duplicated in the recording medium. However, the present invention is not limited to this configuration. For example, the status information transmitted from the status information acquisition sensor group may be directly stored in the recording medium, and then, the information other than specified as the information for verification of cause of failure may be deleted.

### INDUSTRIAL APPLICABILITY

The present invention may be applied in a vehicle manufacturing industry and vehicle parts manufacturing industry.

The present application claims priority from Japanese Patent Application No. 2008-005949 filed on Jan. 15, 2008, the entire contents of which are hereby incorporated herein by reference.

1. A vehicle control device comprising:
a control unit configured to control an in-vehicle device; and
a status information acquisition unit configured to acquire status information of a vehicle and output the acquired status information to the control unit, wherein
the control unit selects the status information which is within a time period from a timing a first predetermined timing period before the start timing of a fail-safe control to a timing a second predetermined timing period after the start timing of the fail-safe control,
the start timing of the fail-safe control is determined based on the status information acquired by the status information acquisition unit,
the control unit specifies the selected status information as information to be used for verifying a cause of a failure,
the control unit stores the specified information to be used for verifying a cause of a failure in a predetermined storage medium, and
the first predetermined timing period is equal to or longer than the second predetermined timing period.

2. (canceled)

3. A vehicle control device comprising:
plural control units configured to control an in-vehicle device; and
a status information acquisition unit configured to acquire status information of a vehicle and output the acquired status information to the control units, wherein
the plural control units select the status information which is within a time period from a timing a first predetermined timing period before the start timing of a fail-safe control to a timing a second predetermined timing period after the start timing of the fail-safe control,
the start timing of the fail-safe control is determined based on the status information acquired by the status information acquisition unit or based on information transmitted from other control unit,
the plural control units specify the selected status information as information to be used for verifying a cause of a failure,
the control unit stores the specified information to be used for verifying a cause of a failure in a predetermined storage medium, and
the first predetermined timing period is equal to or longer than the second predetermined timing period.

4. (canceled)
